(19) United States
(12) Patent Application Publication
(10) Pub. No.: US 2025/0334547 A1
(43) Pub. Date: Oct. 30, 2025

(54) Imaging Analysis Method and Apparatus Using Ion Mobility Mass Spectrometry

(71) Applicant: SHIMADZU CORPORATION, Kyoto-shi (JP)

(72) Inventor: Shinichi YAMAGUCHI, Kyoto-shi (JP)

(21) Appl. No.: 18/879,184

(22) PCT Filed: Jul. 21, 2022
(86) PCT No.: PCT/JP2022/028407

§ 371 Date: Dec. 26, 2024

(51) Int. Cl. G01N 27/623; H01J 49/00

(52) U.S. Cl. CPC G01N 27/623; H01J 49/0004; H01J 49/0036

(57) ABSTRACT

One mode of an imaging analysis apparatus according to the present invention includes: a measurement unit configured to acquire analysis result data by performing ion mobility mass spectrometry for each of a plurality of micro regions in a predetermined measurement region in a sample; a correlation investigation unit (22, 23) configured to investigate a correlation between an m/z and an ion mobility in the analysis result data based on the analysis result data acquired by the measurement unit; and a data reduction unit (24, 25) configured to reduce an amount of the analysis result data by limiting an ion mobility range according to the m/z or limiting an m/z range according to the ion mobility based on the correlation obtained by the correlation investigation unit.

### TECHNICAL FIELD

The present invention relates to an imaging analysis method and apparatus using ion mobility spectrometry—mass spectrometry as an analysis method.

### BACKGROUND ART

As described in Patent Literature 1 or other related documents, in an imaging mass spectrometer, generally, mass spectrum data over a predetermined mass-to-charge ratio (m/z) range is acquired for each micro region obtained by finely dividing a two-dimensional measurement region on a sample. If position information such as two-dimensional coordinates of the micro region on the sample is treated as information along one axis, data acquired by the imaging mass spectrometer is represented by two-dimensional ionic intensity data expressed by two parameters in which one axis expresses the position information and the other axis expresses an m/z value (mass spectrum information) as shown in FIG. 3(A). In this case, the mass spectrum data obtained for a micro region in the measurement region is the ionic intensity data along a horizontal line A in FIG. 3(A).

In mass spectrometry, in principle, a compound and a structural isomer having the same mass as that of the compound cannot be separated and detected. On the other hand, in recent years, an ion mobility mass spectrometer using both ion mobility spectrometry which can separate ions according to a collision cross section and mass spectrometry has been put into practical use. Patent Literature 2 and Non Patent Literature 1 disclose an ion mobility mass spectrometer in which an orthogonal acceleration time-of-flight mass spectrometer is disposed at a subsequent stage of an ion mobility separation unit.

In such an ion mobility mass spectrometer, after ions derived from sample components are separated according to ion mobility, a plurality of types of ions having the same degree of ion mobility can be separated and detected according to the m/z. Therefore, if the ion mobility mass spectrometer is used for imaging analysis, measurement data acquired by the apparatus is represented by three-dimensional ionic intensity data expressed by three parameters in which a first axis expresses the position information, a second axis expresses the m/z value (mass spectrum information), and a third axis expresses the ion mobility (or the collision cross section, a drift time, etc.) as shown in FIG. 3(B). In this case, the measurement data including the mass spectrum and an ion mobility spectrum obtained as information in a micro region in the measurement region is the ionic intensity data on a plane B in FIG. 3(B).

In the following description, an apparatus using the ion mobility mass spectrometer for imaging analysis is referred to as an imaging ion mobility mass spectrometer or imaging IMS-MS. A normal imaging mass spectrometer may be referred to as an imaging MS.

### CITATION LIST

### Patent Literature

Patent Literature 1: JP 2011-191222 A
Patent Literature 2: WO 2015/053039 A

### Non Patent Literature

Non Patent Literature 1: Yun Wang Alelyunas and four others, “Building a Collision Cross Section Library of Pharmaceutical Drugs Using the Vion IMS QTof Platform: Verification of System Performance, Precision and Deviation of CCS Measurements”, [searched on Jul. 4, 2022], Waters Corporation, USA, Internet <URL: https://www.waters.com/webassets/cms/library/docs/720005903en.pdf>
Non Patent Literature 2: “IMAGEREVAL (trademark) MS, MS Imaging Analysis Software”, [searched on Jul. 7, 2022], SHIMADZU CORPORATION, Internet <URL: https://www.an.shimadzu.co.jp/bio/imagereveal/features.htm>

### SUMMARY OF INVENTION

### Technical Problem

In an imaging IMS-MS, a dimension of measurement data is added to the data of an imaging MS. Therefore, the amount of data processed in the analysis remarkably increases. As an example, assuming that the number of elements in each dimension is 10⁴, the total number of the measurement data acquired by the imaging IMS-MS is 10⁴×10⁴×10⁴=10¹². If the digital data is represented by the normally used double-precision floating-point type, in which the size of one piece of measurement data is 8 bytes, the total amount of the measurement data is 8×10¹² bytes=8 TB. This is quite a large amount of data to perform data processing in current standard personal computers (PCs). When the dimension of the measurement data increases, calculation of data analysis processing for searching for images having similar distributions or performing difference analysis of a plurality of images, for example, becomes complicated, and thus the capacity of a random-access memory (RAM) used in the process of calculation should be increased.

For this reason, when a normal PC is used to perform the analysis processing on the measurement data acquired by the imaging IMS-MS, there occurs a shortage in the calculation resources, or the processing speed lowers significantly and the processing time is significantly extended, so that an expensive PC having high performance is required.

The present invention has been made in view of such problems, and one of the main objects of the present invention is to reduce the workload of data processing in the imaging IMS-MS.

### Solution to Problem

A first mode of an imaging analysis method using ion mobility mass spectrometry according to the present invention is an analysis method for analyzing analysis result data obtained by performing ion mobility mass spectrometry for each of a plurality of micro regions in a predetermined measurement region in a sample, the imaging analysis method including:
a correlation investigation step of investigating a correlation between a mass-to-charge ratio and an ion mobility in the analysis result data based on the analysis result data; and
a data reduction step of reducing an amount of the analysis result data by limiting an ion mobility range according to the mass-to-charge ratio or limiting a mass-to-charge ratio range according to the ion mobility based on the correlation obtained in the correlation investigation step.

A first mode of an imaging analysis apparatus using ion mobility mass spectrometry according to the present invention is an apparatus configured to implement the imaging analysis method of the first mode, the imaging analysis apparatus including:
a measurement unit configured to acquire analysis result data by performing ion mobility mass spectrometry for each of a plurality of micro regions in a predetermined measurement region in a sample;
a correlation investigation unit configured to investigate a correlation between a mass-to-charge ratio and an ion mobility in the analysis result data based on the analysis result data acquired by the measurement unit; and
a data reduction unit configured to reduce an amount of the analysis result data by limiting an ion mobility range according to the mass-to-charge ratio or limiting a mass-to-charge ratio range according to the ion mobility based on the correlation obtained by the correlation investigation unit.

A second mode of an imaging analysis method using ion mobility mass spectrometry according to the present invention is an analysis method for analyzing analysis result data obtained by performing ion mobility mass spectrometry for each of a plurality of micro regions in a predetermined measurement region in a sample, the imaging analysis method including:
a data extraction step of performing peak detection on the analysis result data acquired for each of the micro regions and extracting analysis result data corresponding to a peak; and
a dimension merging step of merging two-dimensional axes of a mass-to-charge ratio and an ion mobility into a one-dimensional axis by using a correlation between the mass-to-charge ratio and the ion mobility in the analysis result data extracted in the data extraction step for each of the micro regions.

A second mode of an imaging analysis apparatus using ion mobility spectrometry according to the present invention is an apparatus configured to implement the imaging analysis method of the second mode, the imaging analysis apparatus including:
a measurement unit configured to acquire analysis result data by performing ion mobility mass spectrometry for each of a plurality of micro regions in a predetermined measurement region in a sample;
a data extraction unit configured to perform peak detection on the analysis result data acquired for each of the micro regions and extract analysis result data corresponding to a peak; and
a dimension merging unit configured to merge two-dimensional axes of a mass-to-charge ratio and an ion mobility into a one-dimensional axis using a correlation between the mass-to-charge ratio and the ion mobility in the analysis result data extracted by the data extraction unit for each of the micro regions.

### Advantageous Effects of Invention

With the imaging analysis method and apparatus using the ion mobility spectrometry of the first mode, it is possible to reduce the total amount of analysis result data by limiting the range of the ion mobility or the mass-to-charge ratio. With the imaging analysis method and apparatus using ion mobility spectrometry of the second mode, it is possible to reduce the total amount of analysis result data by performing peak detection and to further reduce the number of dimensions of the data. As a result, according to the present invention, it is possible to reduce the workload of data processing for image analysis, difference analysis, and the like in a PC, and for example, it is possible to use a PC of smaller performances and specifications, or, when a PC of the same performance and specification is used, to accelerate the processing and shorten the processing time.

### BRIEF DESCRIPTION OF DRAWINGS

FIG. 1 A schematic configuration diagram of an imaging IMS-MS according to a first embodiment of the present invention.

FIG. 2 A functional block diagram of a data processing unit of the imaging IMS-MS according to the first embodiment.

FIG. 3 A diagram showing a comparison of dimensions of parameters between measurement data obtained by an imaging MS and measurement data obtained by the imaging IMS-MS.

FIG. 4 A schematic diagram showing a relationship between an m/z value and an ion mobility in measurement data obtained by the imaging IMS-MS.

FIG. 5 A conceptual diagram showing data amounts before and after data reduction in the imaging IMS-MS according to the first embodiment.

FIG. 6 A functional block diagram of a data processing unit of an imaging IMS-MS according to a second embodiment.

FIG. 7 An explanatory diagram of dimension merging processing in the imaging IMS-MS according to the second embodiment.

FIG. 8 A diagram showing an example of a pseudo mass spectrum obtained by imaging analysis in the imaging IMS-MS according to the first embodiment.

FIG. 9 A diagram showing an example of the pseudo mass spectrum obtained by imaging analysis in the imaging IMS-MS according to the second embodiment.

FIG. 10 A diagram showing an example of a table for associating an ID of a peak with the ion mobility and the m/z value in the imaging IMS-MS according to the second embodiment.

### DESCRIPTION OF EMBODIMENTS

Hereinafter, an imaging IMS-MS according to an embodiment of the present invention and an imaging analysis method in the imaging IMS-MS apparatus will be described with reference to the attached drawings.

### First Embodiment

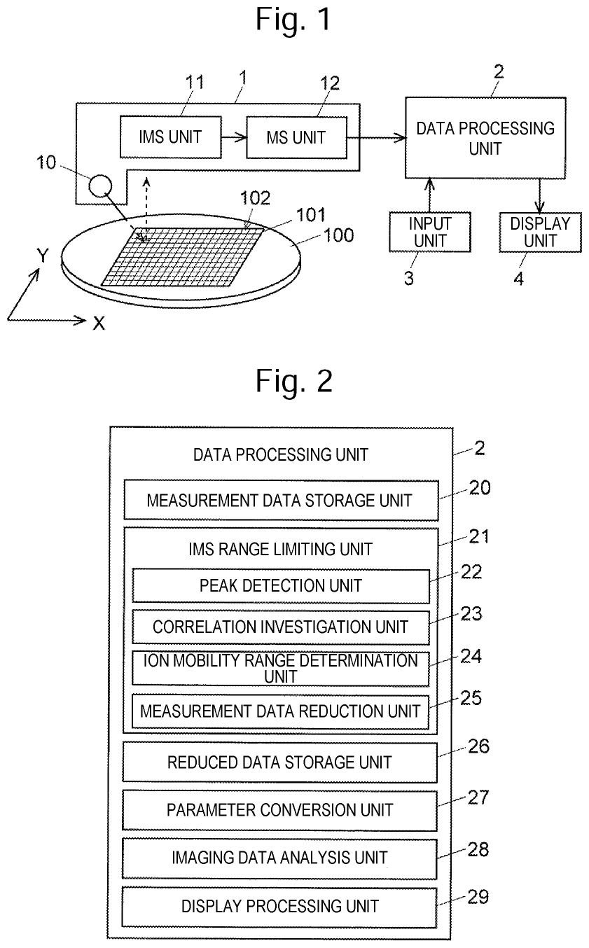

FIG. 1 is a schematic block configuration diagram of an imaging IMS-MS according to a first embodiment. FIG. 2 is a functional block diagram of a data processing unit in the imaging IMS-MS according to the first embodiment.

As shown in FIG. 1, the IMS-MS according to the first embodiment includes a measurement unit 1, a data processing unit 2, an input unit 3, and a display unit 4.

The measurement unit 1 acquires measurement data by performing ion mobility mass spectrometry on a section-shaped sample 100 obtained, for example, by thinly slicing an organ or the like extracted from a living body such as a laboratory animal, and is an atmospheric pressure MALDI (matrix-assisted laser desorption ionization) ion mobility-orthogonal acceleration time-of-flight mass spectrometer (APMALDI-IMS-OATOFMS) as an example. In this case, the measurement unit 1 includes a laser irradiation unit 10 configured to irradiate the sample 100 with a laser beam having a micro diameter in order to perform ionization by an atmospheric pressure MALDI method, an ion mobility separation unit (IMS unit) 11 configured to separate ions generated from the sample 100 by receiving the irradiation of the laser beam according to ion mobility, and a mass spectrometry unit (MS unit) 12 configured to separate and detect the separated ions according to the m/z.

The measurement unit 1 may be an apparatus obtained by combining an apparatus configured to collect a large number of fine sample pieces from a sample by a method such as a laser microdissection method and an apparatus configured to perform ion mobility mass spectrometry on a sample prepared from each collected sample piece.

The data processing unit 2 has a function of processing a large amount of measurement data obtained by the measurement unit 1, and includes, as functional blocks, a measurement data storage unit 20, an IMS range limiting unit 21, a reduced data storage unit 26, a parameter conversion unit 27, an imaging data analysis unit 28, a display processing unit 29, and the like. The IMS range limiting unit 21 includes, as lower functional blocks, a peak detection unit 22, a correlation investigation unit 23, an ion mobility range determination unit 24, and a measurement data reduction unit 25.

In the imaging IMS-MS according to the present embodiment, the data processing unit 2 usually mainly includes a PC or a higher-performance workstation, and can embody the functional blocks by executing, in the computer, dedicated data processing software (computer program) installed in the computer. In this case, the input unit 3 is a keyboard or a pointing device (such as a mouse) attached to the computer, and the display unit 4 is a display monitor.

The above-described computer program can be provided to a user by being stored, for example, in a non-transitory computer-readable recording medium such as a CD-ROM, a DVD-ROM, a memory card, or a USB memory (dongle). In addition, the above program can be provided to a user in the form of data transfer via a communication line such as the Internet. In addition, the program can be pre-installed in a computer which is a part of the system (strictly, a storage device which is a part of the computer) when the user purchases the system.

A measurement operation by the measurement unit 1 will be schematically described.

The sample 100 to be measured is placed on a sample plate (not illustrated), a matrix for MALDI analysis is applied to a surface of the sample plate, and the sample plate is set at a predetermined position of the measurement unit 1. The measurement unit 1 performs ion mobility mass spectrometry for each micro region 102 obtained by finely dividing a predetermined measurement region 101 set on the sample 100 into a lattice shape. That is, in the measurement unit 1, the laser irradiation unit 10 irradiates one micro region 102 with laser light for a short time. Upon irradiation with the laser light, a compound present in the micro region 102 is ionized.

Ions generated from the sample 100 are introduced into the ion mobility separation unit 11 and spatially separated according to the ion mobility. Various ions separated according to the ion mobility are partitioned for each of a plurality of ions included in a predetermined ion mobility range (range that can be regarded as substantially the same), and are sequentially sent to the mass separation unit 12. Then, the plurality of ions partitioned in one are detected after being separated according to the m/z in the mass separation unit 12.

In the mass separation unit 12, mass spectrometry is repeated for one ion packet including a plurality of ions included in the ion mobility range in which the ion mobility can be regarded as substantially the same. As a result, measurement data corresponding to one micro region 102 on the sample 100, that is, having one piece of position information on the sample 100 and having parameters of both ion mobility and m/z, is obtained. That is, the measurement data is ion mobility spectrum data indicating a relationship between the ion mobility and ionic intensity, and is also mass spectrum data indicating a relationship between the m/z value and the ionic intensity.

The measurement unit 1 repeats the same measurement operation while moving the sample 100 in an X-Y plane such that an irradiation position of the laser beam is moved on the sample 100 by a driving unit (not illustrated). As a result, measurement data is collected for all the micro regions 102 set in the measurement region 101 on the sample 100. In general, the user may appropriately set the position, size, shape, and the like of the measurement region 101 on the sample 100 by optical microscopic observation or the like.

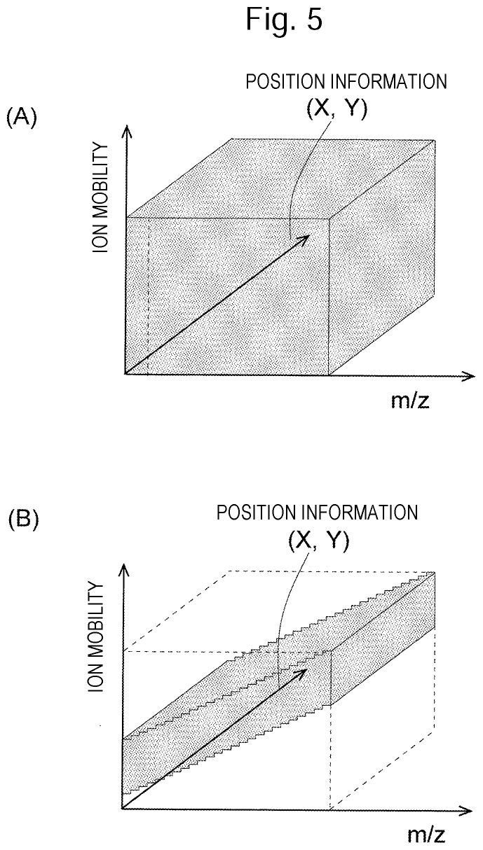

The measurement data in each micro region 102 collected by the measurement as described above is transferred from the measurement unit 1 to the data processing unit 2 and temporarily stored in the measurement data storage unit 20. As shown in FIG. 5(A), the measurement data obtained for one sample 100 (or one measurement region 101) is three-dimensional ionic intensity data having three parameters of position information (for example, position coordinates (X, Y)), ion mobility, and m/z of the micro region 102. The amount of measurement data in an axial direction of the position information depends on the number of micro regions 102. The amount of measurement data in the axial direction of the m/z depends on an m/z range to be measured and a step width of the m/z value within the range. The amount of measurement data in the axial direction of the ion mobility depends on the ion mobility range to be measured and the step width of the ion mobility value within the range.

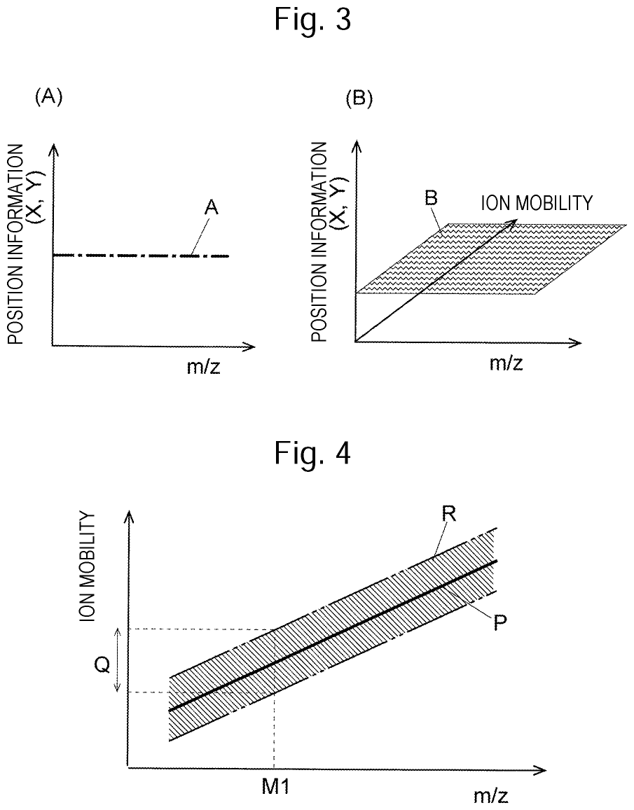

In the data processing unit 2, for example, an analysis process is executed on the basis of the measurement data for creating an image indicating an ionic intensity distribution at a specific m/z value or a specific ion mobility, searching for the m/z value or the ion mobility value indicating a characteristic distribution, or searching for a plurality of m/z values or ion mobility values having similar ionic intensity distributions. Here, the imaging mass spectrometry data analysis software described in Non Patent Literature 2 or other related documents is used for such data analysis processing, but if an attempt is made to process measurement data acquired by measurement data in its original form, there are the following problems.
(1) Since a dimension of a parameter is added to the data of imaging mass spectrometry, the total amount of the measurement data is large, and the workload is too large to process with a standard PC.
(2) The imaging mass spectrometry data analysis software as described above is based on a premise that two-dimensional ionic intensity data having two parameters of position information and m/z as shown in FIG. 3(A) is processed, and thus three-dimensional ionic intensity data having three parameters cannot be handled in its original form.

On the other hand, in the imaging IMS-MS according to the first embodiment, analysis is performed after the following data processing is performed on the basis of the measurement data.

The ion mobility is proportional to the collision cross section of the ion, which is related to the mass of the ion. Therefore, as shown in Non Patent Literature 1, there is a correlation between the ion mobility and the m/z value. Therefore, the ion mobility and the m/z in the measurement data acquired by the IMS-MS can be generally included in a range R indicated by hatching in FIG. 4, that is, the range R having a width Q with a straight line P as a center line. In other words, it can be considered that there is no significant measurement data outside this range R. Therefore, in the imaging IMS-MS according to the first embodiment, the correlation between the ion mobility and the m/z value is used to delete measurement data assumed to be insignificant to thereby reduce the total amount of data.

Specifically, first, in order to investigate the correlation between the ion mobility and the m/z value, the peak detection unit 22 of the IMS range limiting unit 21 uses the acquired measurement data to detect a peak of the ionic intensity on a plane B as illustrated in FIG. 3(B) for each micro region, and obtains a combination of the ion mobility value at which the peak appears as peak information and the m/z value. The correlation investigation unit 23 performs regression analysis using a large number of pieces of obtained peak information, and calculates a regression line indicating the most likely relationship between the ion mobility and the m/z. This regression line is the straight line P in FIG. 4.

The ion mobility range determination unit 24 calculates the width Q as a function of the m/z value from a dispersion degree or the like of the peak obtained as a result of the regression analysis. As a result, the range R in which the presence of the measurement data is permitted is determined. Then, the measurement data reduction unit 25 reduces the range of the ion mobility, which is one of the parameters in the acquired measurement data, according to the m/z value, and reduces the total amount of the measurement data by deleting the measurement data having the ion mobility outside the range. A range in which the reduced measurement data exists is as shown in FIG. 5(B). Measurement data having a parameter that is within a range of a filled cube in FIG. 5(A) and is positioned outside a range of a filled solid in FIG. 5(B) is deleted. However, most of the measurement data to be actually deleted is zero data or noise data, and does not substantially affect a result of analysis described later.

For example, if the number of elements in each dimension is 10⁴ and the number of elements of ion mobility is limited to 10² for each m/z value as described above, the total number of the measurement data is 10⁴×10⁴×10²=10¹⁰. That is, the total number of measurement data is compressed to 1/100 as compared with a case where data reduction is not performed. The reduced measurement data is temporarily stored in the reduced data storage unit 26.

In the case shown in FIG. 5(A), the range of ion mobility is common regardless of the m/z value, but in the case shown in FIG. 5(B), the range of ion mobility depends on the m/z value. Therefore, it is necessary to associate an equation indicating the straight line P and a value of the width Q or information corresponding to the equation and the value as shown in FIG. 4 with the reduced measurement data. By using this information, for example, the value of the ion mobility can be obtained from the m/z value and a position in the ion mobility range (width Q).

In the above data reduction method, the number of parameters, that is, the number of dimensions of the measurement data, does not reduce, but the load on the PC is reduced by reducing the total amount of the measurement data. However, in order to perform data processing by analysis software on the premise of processing two-dimensional ionic intensity data as described above, it is necessary to be able to handle two parameters of the m/z value and the ion mobility as one parameter for convenience.

Therefore, prior to the analysis process, the parameter conversion unit 27 performs a process of converting two parameters of the ion mobility and the m/z value in each measurement data into one parameter integrated for convenience. As an example, a fractional part of the numerical value of the ion mobility and the numerical value of the m/z value is rounded down (or rounded off), and then the numerical value of an integer part is assigned to the numerical value of the ion mobility and the numerical value of the fractional part is assigned to the numerical value of the m/z, so that the parameter can be handled as one parameter for convenience. For example, if there is an ion peak having an ion mobility (collision cross section) of 200 [ccs] and an m/z value of 300, the ion peak may be expressed by one numerical value such as “200.300”. Alternatively, without using a decimal point, numerical values from the most significant digit to a specific number of digits among numerical values of a predetermined number of digits may be assigned to the ion mobility, and numerical values of the remaining digits may be assigned to the m/z. For example, if the upper four digits are assigned to the ion mobility and the lower four digits are assigned to the m/z with a numerical value of eight digits, the ion peak having an ion mobility (collision cross section) of 200 [ccs] and an m/z value of 300 is expressed by a numerical value “02000300”.

The imaging data analysis unit 28 reads the measurement data in which the ion mobility and the m/z value are changed for convenience as described above, and executes data processing instructed by the user through the input unit 3. For example, when an image showing a distribution of a compound having a specific m/z value and a specific ion mobility is created, measurement data for each micro region having a parameter value for convenience obtained by combining the specific m/z value and the specific ion mobility is extracted, and the image may be created on the basis of the value of the measurement data (ionic intensity value). The display processing unit 29 displays the image thus created on the screen of the display unit 4 and provides the image to the user.

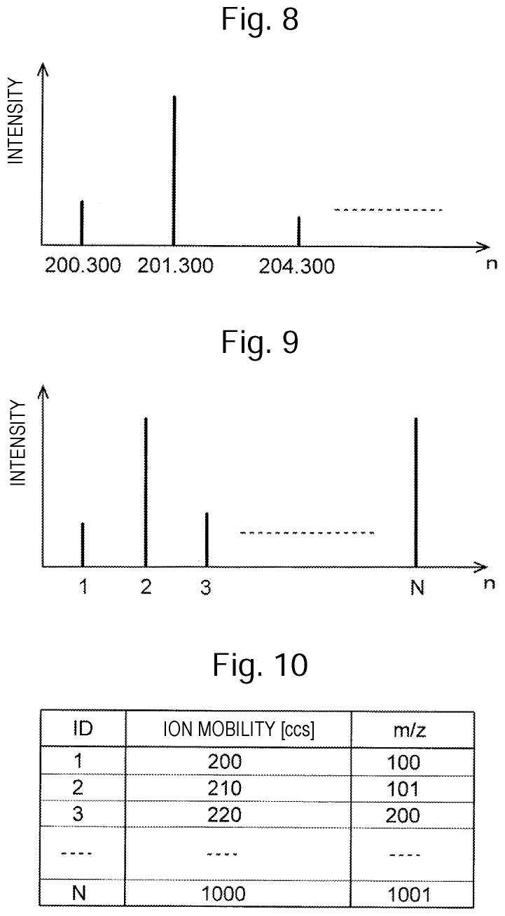

In addition, the imaging data analysis unit 28 can create a spectrum along a parameter axis after the conversion, similar to a mass spectrum in a micro region at a specific position, by processing the measurement data in the same manner as when analyzing the imaging mass spectrometry data. FIG. 8 illustrates an example of such a spectrum, and the horizontal axis is a new parameter axis in which the ion mobility and the m/z value are integrated for convenience. From the spectrum data thus obtained, a numerical value of only the integer part of the horizontal axis is extracted, and intensities of a plurality of peaks having the same numerical value are added up to create a new spectrum, whereby an ion mobility spectrum in the micro region can be obtained. The mass spectrum in the micro region can be obtained by extracting a numerical value only in the fractional part on the horizontal axis from the spectrum data and adding up the intensities of the plurality of peaks having the same numerical value to create a new spectrum.

### Second Embodiment

Next, an imaging IMS-MS according to a second embodiment different from the first embodiment in terms of the data reduction method will be described. Since the configuration of the measurement unit 1 is the same as the configuration according to the first embodiment, the description of the configuration will be omitted, and a configuration and processing operation of the data processing unit different from those according to the first embodiment will be described.

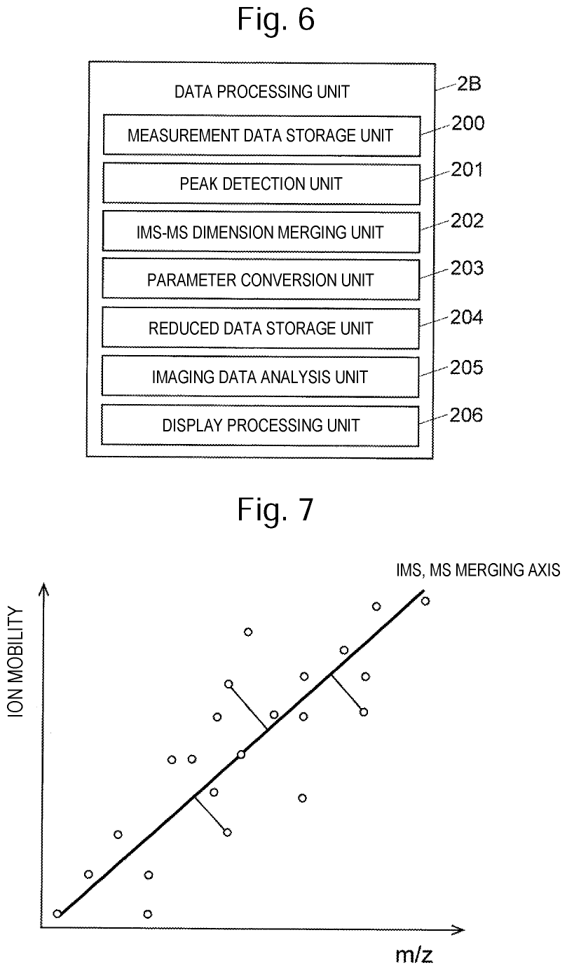

FIG. 6 is a functional block configuration diagram of a data processing unit 2B in the imaging IMS-MS according to the second embodiment. The data processing unit 2B includes, as functional blocks, a measurement data storage unit 200, a peak detection unit 201, an IMS-MS dimension merging unit 202, a parameter conversion unit 203, a reduced data storage unit 204, an imaging data analysis unit 205, a display processing unit 206, and the like.

In the imaging IMS-MS of this embodiment, the peak detection unit 201 executes peak detection on a plane of the ion mobility and the m/z value for each micro region for measurement data of all micro regions, and obtains peak information including the ion mobility and the m/z value at which a peak appears, and a peak intensity. This processing is substantially the same as the processing performed by the peak detection unit 22 in the first embodiment. However, in the second embodiment, the data amount is reduced by leaving only the measurement data corresponding to the detected peak.

Next, the IMS-MS dimension merging unit 202 merges two dimensions of the ion mobility and the m/z value for each of the plurality of detected peaks into one dimension for each micro region to obtain a new axis. Specifically, for example, first, for each micro region, as shown in FIG. 7, regression analysis is performed using the plurality of peaks positioned on an orthogonal axis between the ion mobility axis and the m/z axis to obtain a regression line. This regression line is the new axis after dimension merging. Then, as shown in an example in FIG. 7, a line orthogonal to the new axis is drawn from a plot corresponding to each peak, and a position of an intersection between the line and the new axis is determined as a new variable corresponding to the plot on the new axis. In other words, the variable after dimension merging is obtained by projecting the plot corresponding to each peak on the regression line. This is a method of dimension merging substantially similar to principal component analysis.

The new axis is an axis obtained by mixing the ion mobility and the m/z value, but a numerical value on the axis is different from both the ion mobility and the m/z value. It is impossible to back calculate the original ion mobility and m/z value from the numerical value on the new axis. That is, the above processing is an irreversible conversion operation. Therefore, in this case, it is necessary to prepare information for associating the numerical value on the new axis with the original ion mobility and m/z value.

Therefore, the parameter conversion unit 203 determines the variable on the new axis for each measurement data, and creates information associating the variable with the original ion mobility and m/z value. As an example, the parameter conversion unit 203 allocates a unique ID (for example, a continuous number) to each detected peak, and sets the ID as a numerical value of the variable on the new axis. Then, a table as illustrated in FIG. 10 is created in which the ID is associated with the original ion mobility and m/z value. In this way, the measurement data in which the data amount is reduced and the number of dimensions of the parameter reduces from three dimensions to two dimensions, and the table for associating the ID with the ion mobility and the m/z value are stored in the reduced data storage unit 204.

When execution of the analysis processing is instructed by the user via the input unit 3, the imaging data analysis unit 205 reads the measurement data from the reduced data storage unit 204 and executes the instructed data processing. In this case, when the mass spectrum is displayed by data analysis, as illustrated in FIG. 9, the ID is sequentially disposed on the m/z axis, and a pseudo mass spectrum indicating the peak corresponding to the ID value can be displayed similarly to the mass spectrum. The ion mobility spectrum and the mass spectrum can be obtained by obtaining the ion mobility and the m/z value from the ID value in the pseudo mass spectrum displayed in this manner with reference to the table for association, and drawing each graph with the horizontal axis as the ion mobility or the m/z value.

Instead of allocating a unique ID to each peak as described above, the parameter conversion unit 203 may determine an appropriate scale along the new axis, which is the regression line obtained as illustrated in FIG. 7, and determine the numerical value on the axis corresponding to each peak according to the scale. Also in this case, a table for associating the numerical value on the new axis with the original ion mobility and m/z value is prepared. For example, if there is the ion peak having an ion mobility (collision cross section) of 200 [ccs] and an m/z of 300, a numerical value corresponding to the peak on the new axis is assumed to be 123. In this case, when the mass spectrum is displayed by data analysis, the pseudo mass spectrum can be created as if the peak has been observed at an m/z of 123.

For example, in a case where a compound corresponding to the detected peak is identified by identification processing, the compound name may be added to the table for association as shown in FIG. 10. In this case, when the pseudo mass spectrum is created, the compound name may be described along the horizontal axis instead of the ID or the like, and a peak may be drawn at a position of the compound name.

The above embodiments are merely examples of the present invention, and it is a matter of course that modifications, corrections, additions, and the like appropriately made within the scope of the gist of the present invention are included in the claims of the present application.

### VARIOUS MODES OF INVENTION

It will be understood by those skilled in the art that the exemplary embodiments described above are specific examples of the following modes.

(Clause 1) One mode of an imaging analysis method using ion mobility mass spectrometry according to the present invention is an analysis method for analyzing analysis result data obtained by performing ion mobility mass spectrometry for each of a plurality of micro regions in a predetermined measurement region in a sample, and the analysis method includes:
a correlation investigation step of investigating a correlation between a mass-to-charge ratio and an ion mobility in the analysis result data based on the analysis result data; and
a data reduction step of reducing an amount of the analysis result data by limiting an ion mobility range according to the mass-to-charge ratio or limiting a mass-to-charge ratio range according to the ion mobility based on the correlation obtained in the correlation investigation step.

(Clause 3) One mode of an imaging analysis apparatus using ion mobility mass spectrometry according to the present invention includes:
a measurement unit configured to acquire analysis result data by performing ion mobility mass spectrometry for each of a plurality of micro regions in a predetermined measurement region in a sample;
a correlation investigation unit configured to investigate a correlation between a mass-to-charge ratio and an ion mobility in the analysis result data based on the analysis result data acquired by the measurement unit; and
a data reduction unit configured to reduce an amount of the analysis result data by limiting an ion mobility range according to the mass-to-charge ratio or limiting a mass-to-charge ratio range according to the ion mobility based on the correlation obtained by the correlation investigation unit.

(Clause 5) Another mode of an imaging analysis method using ion mobility mass spectrometry according to the present invention is an analysis method for analyzing analysis result data obtained by performing ion mobility mass spectrometry for each of a plurality of micro regions in a predetermined measurement region in a sample, and the imaging analysis method includes:
a data extraction step of performing peak detection on the analysis result data acquired for each of the micro regions and extracting analysis result data corresponding to a peak; and
a dimension merging step of merging two-dimensional axes of a mass-to-charge ratio and an ion mobility into a one-dimensional axis by using a correlation between the mass-to-charge ratio and the ion mobility in the analysis result data extracted in the data extraction step for each of the micro regions.

(Clause 8) Another mode of an imaging analysis apparatus using ion mobility mass spectrometry according to the present invention includes:
a measurement unit configured to acquire analysis result data by performing ion mobility mass spectrometry for each of a plurality of micro regions in a predetermined measurement region in a sample;
a data extraction unit configured to perform peak detection on the analysis result data acquired for each of the micro regions and extract analysis result data corresponding to a peak; and
a dimension merging unit configured to merge two-dimensional axes of a mass-to-charge ratio and an ion mobility into a one-dimensional axis using a correlation between the mass-to-charge ratio and the ion mobility in the analysis result data extracted by the data extraction unit for each of the micro regions.

With the imaging analysis method according to clause 1 or clause 5, it is possible to reduce the total amount of analysis result data by limiting the range of the ion mobility or the mass-to-charge ratio. With the imaging analysis apparatus according to clause 3 or clause 7, it is possible to reduce the total amount of analysis result data by performing peak detection and further reduce the number of dimensions of the data. As a result, with these analysis methods or analysis apparatuses, it is possible to reduce the workload of data processing for image analysis, difference analysis, and the like in a PC, and for example, it is possible to use a PC of lower performances and specifications, or, when a PC of the same performance and specification is used, to accelerate the processing and shorten the processing time.

(Clause 2) The imaging analysis method using ion mobility mass spectrometry according to clause 1 may further include a parameter conversion step of converting the analysis result data after reduction in the data reduction step into a provisional parameter in which values of the ion mobility and the mass-to-charge ratio, which are parameters of each data, are merged into one numerical value.

(Clause 4) The imaging analysis apparatus using ion mobility mass spectrometry according to clause 3 may further include a parameter conversion unit configured to convert the analysis result data after reduction by the data reduction unit into a provisional parameter in which values of the ion mobility and the mass-to-charge ratio, which are parameters of each data, are merged into one numerical value.

In the analysis method according to clause 2 and the analysis apparatus according to clause 4, for example, numerical values of a plurality of specific digits in one numerical value of a plurality of digits can be assigned to the ion mobility, and numerical values of a plurality of remaining digits can be assigned to the mass-to-charge ratio. Alternatively, a numerical value of an integer part can be assigned to the ion mobility, and a numerical value after a decimal point can be assigned to the mass-to-charge ratio.

With the analysis method according to clause 2 and the analysis apparatus according to clause 4, analysis result data having three-dimensional parameters such as position information, ion mobility, and mass-to-charge ratio can be apparently treated as analysis result data having two-dimensional parameters. This makes it possible to perform analysis processing using existing imaging mass spectrometry data analysis software on a premise that the parameters are two-dimensional.

(Clause 6) The imaging analysis method according to clause 5 may further include a variable conversion step of giving a new variable along the one-dimensional axis to each of the extracted analysis result data and creating information indicating a correspondence relationship between a value of the variable and the original ion mobility and mass-to-charge ratio.

(Clause 7) The imaging analysis method according to clause 5 may further include a variable conversion step of assigning a unique number to each of the extracted analysis result data and creating information indicating a correspondence relationship between the unique number and the original ion mobility and mass-to-charge ratio.

(Clause 9) The imaging analysis apparatus according to clause 8 may further include a variable conversion unit configured to give a new variable along the one-dimensional axis to each of the extracted analysis result data and create information indicating a correspondence relationship between a value of the variable and the original ion mobility and mass-to-charge ratio.

(Clause 10) The imaging analysis apparatus according to clause 8 may further include a variable conversion unit configured to assign a unique number to each of the extracted analysis result data and create information indicating a correspondence relationship between the unique number and the original ion mobility and mass-to-charge ratio.

With the analysis apparatus according to any one of clauses 6, 7, 9, or 10, analysis processing using existing imaging mass spectrometry data analysis software on the premise that the parameters are two-dimensional can be performed.

### REFERENCE SIGNS LIST

1 . . . Measurement Unit
10 . . . Laser Irradiation Unit
11 . . . Ion Mobility Separation Unit (IMS Unit)
12 . . . Mass Separation Unit (MS Unit)
2, 2B . . . Data Processing Unit
20, 200 . . . Measurement Data Storage Unit
21 . . . IMS Range Limiting Unit
22, 201 . . . Peak Detection Unit
23 . . . Correlation Investigation Unit
24 . . . Ion Mobility Range Determination Unit
25 . . . Measurement Data Reduction Unit
26, 204 . . . Reduced Data Storage Unit
27, 203 . . . Parameter Conversion Unit
28, 205 . . . Imaging Data Analysis Unit
29, 206 . . . Display Processing Unit
202 . . . IMS-MS Dimension Merging Unit
3 . . . Input Unit
4 . . . Display Unit
100 . . . Sample
101 . . . Measurement Region
102 . . . Micro Region

1. An imaging analysis method using ion mobility mass spectrometry that is an analysis method for analyzing analysis result data obtained by performing ion mobility mass spectrometry for each of a plurality of micro regions in a predetermined measurement region in a sample, the imaging analysis method comprising:
a correlation investigation step of investigating a correlation between a mass-to-charge ratio and an ion mobility in the analysis result data based on the analysis result data; and
a data reduction step of reducing an amount of the analysis result data by limiting an ion mobility range according to the mass-to-charge ratio or limiting a mass-to-charge ratio range according to the ion mobility based on the correlation obtained in the correlation investigation step.

2. The imaging analysis method using ion mobility mass spectrometry according to claim 1, further comprising a parameter conversion step of converting the analysis result data after reduction in the data reduction step into a provisional parameter in which values of the ion mobility and the mass-to-charge ratio, which are parameters of each data, are merged into one numerical value.

3. An imaging analysis apparatus using ion mobility mass spectrometry, the imaging analysis apparatus comprising:
a measurement unit configured to acquire analysis result data by performing ion mobility mass spectrometry for each of a plurality of micro regions in a predetermined measurement region in a sample;
a correlation investigation unit configured to investigate a correlation between a mass-to-charge ratio and an ion mobility in the analysis result data based on the analysis result data acquired by the measurement unit; and
a data reduction unit configured to reduce an amount of the analysis result data by limiting an ion mobility range according to the mass-to-charge ratio or limiting a mass-to-charge ratio range according to the ion mobility based on the correlation obtained by the correlation investigation unit.

4. The imaging analysis apparatus using ion mobility mass spectrometry according to claim 3, further comprising a parameter conversion unit configured to convert the analysis result data after reduction by the data reduction unit into a provisional parameter in which values of the ion mobility and the mass-to-charge ratio, which are parameters of each data, are merged into one numerical value.

5. An imaging analysis method using ion mobility mass spectrometry that is an analysis method for analyzing analysis result data obtained by performing ion mobility mass spectrometry for each of a plurality of micro regions in a predetermined measurement region in a sample, the imaging analysis method comprising:
a data extraction step of performing peak detection on the analysis result data acquired for each of the micro regions and extracting analysis result data corresponding to a peak; and
a dimension merging step of merging two-dimensional axes of a mass-to-charge ratio and an ion mobility into a one-dimensional axis by using a correlation between the mass-to-charge ratio and the ion mobility in the analysis result data extracted in the data extraction step for each of the micro regions.

6. The imaging analysis method using ion mobility mass spectrometry according to claim 5, further comprising a variable conversion step of giving a new variable along the one-dimensional axis to each of the extracted analysis result data and creating information indicating a correspondence relationship between a value of the variable and the original ion mobility and mass-to-charge ratio.

7. The imaging analysis method using ion mobility mass spectrometry according to claim 5, further comprising a variable conversion step of assigning a unique number to each of the extracted analysis result data and creating information indicating a correspondence relationship between the unique number and the original ion mobility and mass-to-charge ratio.

8. An imaging analysis apparatus using ion mobility mass spectrometry, the imaging analysis apparatus comprising:
a measurement unit configured to acquire analysis result data by performing ion mobility mass spectrometry for each of a plurality of micro regions in a predetermined measurement region in a sample;
a data extraction unit configured to perform peak detection on the analysis result data acquired for each of the micro regions and extract analysis result data corresponding to a peak; and
a dimension merging unit configured to merge two-dimensional axes of a mass-to-charge ratio and an ion mobility into a one-dimensional axis using a correlation between the mass-to-charge ratio and the ion mobility in the analysis result data extracted by the data extraction unit for each of the micro regions.

9. The imaging analysis apparatus using ion mobility mass spectrometry according to claim 8, further comprising a variable conversion unit configured to give a new variable along the one-dimensional axis to each of the extracted analysis result data and create information indicating a correspondence relationship between a value of the variable and the original ion mobility and mass-to-charge ratio.

10. The imaging analysis apparatus using ion mobility mass spectrometry according to claim 8, further comprising a variable conversion unit configured to assign a unique number to each of the extracted analysis result data and create information indicating a correspondence relationship between the unique number and the original ion mobility and mass-to-charge ratio.
